(19) United States
(12) Patent Application Publication
(10) Pub. No.: US 2012/0118905 A1
(43) Pub. Date: May 17, 2012

(54) DISPENSER FOR DISPENSING TISSUE AND/OR NONWOVEN PRODUCTS AND METHOD FOR DISPENSING TISSUE AND/OR NONWOVEN PRODUCTS

(75) Inventor: Jannike Lindbergh, Skellefteå (SE)

(73) Assignee: SCA Hygiene Products AB, Göteborg (SE)

(21) Appl. No.: 13/322,933

(22) PCT Filed: Jun. 10, 2009
(86) PCT No.: PCT/EP09/57173

§ 371 Date: Jan. 19, 2012

(51) Int. Cl. A47K 10/42; B65G 59/00; B65D 83/00

(52) U.S. Cl. 221/1; 221/46; 221/197

(57) ABSTRACT

The present disclosure pertains to a dispenser (1) for dispensing tissue and/or nonwoven products (100), preferably wet wipes, the dispenser comprising a containing body (2) defining a volume (200) for receiving the products to be dispensed and a covering body (3), wherein the containing body comprises a main section (20) and a connecting section (22), the connecting section having dimensions to be at least partly received in the covering body, and wherein the containing body and the covering body are connected to one another by the connecting section such that the covering body is movable with respect to the containing body from a closed configuration to a dispensing configuration, wherein a dispensing opening (24) is present in the connecting section for dispensing in the dispensing configuration the products from the volume, wherein covering body covers the dispensing opening in the closed configuration.

### TECHNICAL FIELD

The present invention pertains to a dispenser for dispensing tissue and/or nonwoven products, preferably facial tissues, handkerchiefs, napkins, tissue papers etc., in particular in the form of wet wipes. The invention, furthermore, pertains to a method for dispensing tissue and/or nonwoven products from this dispenser.

### TECHNOLOGICAL BACKGROUND

In the field of dispensers for dispensing tissue and/or nonwoven products, it is known to provide cardboard boxes from which the tissue and/or nonwoven products, in particular facial tissue and/or nonwoven products, can be dispensed. These boxes are, however, typically not suitable for dispensing wet tissue and/or nonwoven products because the cardboard material of the box would soak through.

Accordingly, for distributing and dispensing wet wipes, i.e. moist toilet paper, moist facial tissues or wipes for cleaning the hands, packages made from a plastic material are conventionally used. In this field, so-called flow packages made from a plastic film material are typically used, wherein the plastic material is suitable for sealing the tissue and/or nonwoven products contained in the package hermetically for distribution. Accordingly, the products do not loose their moisture content and can be dispensed from the plastic film package without degrading the package.

These flexible plastic film packages function pretty well as long as the package is almost full, but it typically becomes difficult dispensing the last few wet wipes from these flexible packages, as the packages tend to bend and distort such that, quite often, more than one wet wipe is dispensed at a time undesirably.

Flexible packages of this kind made from a plastic film material are also typically known in the field of baby care products where these wet wipes are used to clean the baby when changing the diapers.

Typically, the dispensing openings in these plastic flow packages are closed for distribution, and are re-closed after use by means of an adhesive strip. Frequently, the adhesive becomes less sticky after several dispensing cycles. Furthermore, the moisture and oily additives contained in the wet wipes may reduce the adhesion of the adhesive strip around the dispensing opening such that proper sealing is degrading and frequently cannot be achieved any more. Accordingly, the packages become untidy after a while and the wet wipes contained inside the package dry out because the opening cannot be sealed properly.

US 2008/0142403 A1 pertains to a rather rigid dispensing device which has a storage compartment. Personal care products can be dispensed from this device through an opening in the device. This device is not suitable for dispensing wet wipes.

### SUMMARY OF THE INVENTION

Accordingly, an object of the present invention is to provide an alternative dispenser for tissue and/or nonwoven products, in particular for dispensing wet wipes, in which the dispensing, handling and moisture-containing functions are improved.

This object is solved by a dispenser with the features of claim 1.

The dispenser for dispensing tissue and/or nonwoven products, preferably wet wipes, comprises a containing body defining a volume for receiving the products to be dispensed and a covering body. The containing body comprises a main section and a connecting section, wherein the connecting section has dimensions to be at least partly received in the covering body. The containing body and the covering body are connected to one another by the connecting section such that the covering body is movable with respect to the containing body from a closed configuration to a dispensing configuration. A dispensing opening is present in the connecting section for dispensing, in the dispensing configuration, the products from the volume, wherein covering body covers the dispensing opening in the closed configuration.

By the provision of the containing body and the covering body in a manner such that the containing body and the covering body are movable with respect to one another, a dispenser is provided which can be transformed from a closed configuration, in which the tissue and/or nonwoven products received in the volume of the containing body are securely stored and covered, into a dispensing configuration, in which the tissue and/or nonwoven products can be dispensed from the dispenser. In particular, by simply moving the two housing bodies, namely the containing body and the covering body, the dispenser can be easily handled by a user and can be opened and closed in an intuitively understandable manner.

The dispensing function, in particular for wet wipes, is improved by the provision of the dispensing opening in the containing body, wherein the dispensing opening can be covered by the covering body. In particular wet wipes have specific needs as to the dispensing function because wet wipes are typically very limp on the one hand, but, on the other hand, have a relatively high friction/adherence to the other wet wipes contained in a wet wipe stack. In particular, it is hardly possible to dispense wet wipe sheets from a stack by means of a mechanical dispensing device.

Accordingly, the provision of a dispensing opening in the connecting section, in which the tissue and/or nonwoven products are contained, has the advantage that the tissue and/or nonwoven products are neither crinkled nor become untidy when the covering body is moved from the closed configuration to the dispensing configuration. This is in particular the case as the dispensing opening and, thus, the wet wipes situated below the dispensing opening are covered by the respective wall of the containing body. By means of this arrangement, it is ensured that the tissue and/or nonwoven products hardly move relative to the containing body. This arrangement substantially improves the dispensing function of the dispenser, in particular with respect to wet wipes.

The dispensing opening may be defined in a first plane of the connecting section, and an insertion opening for inserting the tissue and/or nonwoven products into the volume may be defined in a second plane, preferably in a plane perpendicular to the first plane.

The provision of the dispensing opening in a first plane of the containing body, and the insertion opening in a second plane which is preferably perpendicular to the first plane of the containing body enables the provision of a safe storage of the tissue and/or nonwoven products and an easy dispensing in a first direction, while opening up the possibility of easily inserting new tissue and/or nonwoven products to be dispensed, if necessary, in a different direction. As the insertion opening is situated in a different plane than the dispensing opening, the insertion opening can be covered easily by the covering body.

The dispensing opening may have a maximum extension which is aligned in a direction inclined with respect to the general extension of the containing body. The dispensing opening may be formed in a longitudinal, elliptical, egg-shaped or oval manner in order to be in a position to easily dispense the tissue and/or nonwoven products product received in the volume of the containing body. The inclination is to be understood in a sense that the maximum extension of the dispensing opening defines a direction and this direction is different from one of the main directions of the dispenser, in particular with respect to the main directions of the dispenser housing, in particular with respect to the longitudinal direction thereof.

The provision of the dispensing opening in this inclined orientation has the advantage that tissue and/or nonwoven products, preferably wet wipes, which are received in the volume of the containing body can be easily grasped by the user, irrespective of where the actual leading portion of the respective tissue and/or nonwoven product is situated. In other words, it is easier to grasp the respective tissue and/or nonwoven product because the position of the respective leading end of the tissue and/or nonwoven product does not need to be positioned in a very accurate way below the dispensing opening, but can be situated more freely. This also opens up more possibilities of using different types of paper, as the user can easily grip the leading end of the papers, allowing a higher variance of the actual paper sizes.

Specifically, if the leading edge of the respective sheets to be dispensed from the dispenser are aligned in a direction substantially perpendicular to the maximum extension of the dispensing opening, it becomes easily possible for users to grasp the leading edge because there is enough room for the users to use their fingers, for example the index and the thumb, along a relatively long section of the sheet to be dispensed. By means of this configuration, the users also get into contact with a substantial amount of sheet material which enables the users to easily grasp the sheet and the leading edges. The alignment of the leading edge of the respective sheet can be along the direction of movement between the containing body and the covering body.

The containing body and the covering body may be slid linearly with respect to one another from the closed configuration to the dispensing configuration. This movement enables an easy opening and closing of the dispenser and, thus, an easy handling.

The dispensing opening may be situated in a plane which extends in parallel to the linear movement direction, whereas an insertion opening may be situated in a plane perpendicular to the linear movement direction. By the provision of the dispensing opening in a plane parallel to the linear movement, the dispensing opening can be easily opened when moving the containing body relative to the covering body, wherein the insertion opening remains covered.

The actual movement of the containing body and the covering body with respect to one another may be restricted by at least one stopping means such that the containing body and the covering body can only be moved between the closed configuration and the dispensing configuration.

The at least one stopping means may be provided in the form of at least one stopping protrusion and/or stopping depression in the connecting section and at least one complementary stopping protrusion and/or stopping depression in the covering body.

However, the at least one stopping means may be shaped such that it can be overcome by the application of slightly higher forces in order to disassemble the containing body and the covering body, in particular to access an insertion opening for inserting a new stack of tissue paper to be dispensed from the dispenser.

The containing body and the covering body may come apart when the stopping means is overcome. In other words, containing body and covering body are separate parts which can be connected to close the dispenser and can be assembled to insert new paper to be dispensed.

Furthermore, the containing body may have a main section and a connecting section, wherein the connecting section has reduced outer dimensions with respect to the main section of the containing body in a plane perpendicular to the movement direction, and the connecting section is receivable in the covering body to movably connect the containing body and the covering body.

By means of the connecting section it becomes possible to provide a strong connection and guidance between the covering body and the containing body and to securely connect the covering body to the containing body. As the connecting section has reduced outer dimensions with respect to the main section of the containing body, the dispenser may be provided with a unique appearance when it is closed, as well as when it is in its opened configuration.

The dispensing opening may be situated in the connecting section, such that it is opened and closed by the relative movement of the connecting section and the covering body.

The insertion opening is preferably situated also in the connecting section in a plane perpendicular to the movement direction of the containing body and the covering body.

The containing body and the covering body form, in the closed configuration, a substantially smooth and even outer configuration of the dispenser. The dispenser may have rounded outer contours. The main section of the containing body and the covering body may have complementary outer shapes, such as to form, when in the closed configuration, a fully closed configuration. Preferably, the outer contours give, at the splitting section between the containing body and the covering body, the impression of a meandering line.

A sealing may be present at the containing body and/or the covering body such as to provide a moisture-proof sealing when the dispenser is in the closed configuration. The provision of this additional sealing improves the handling of the dispenser as it can be more flexibly and independently used and the time until wet wipes get dry is substantially extended.

In order to improve the handling when using the dispenser together with a flexible package containing the tissue and/or nonwoven products to be dispensed, a holding means may be present in the containing body in the vicinity of the dispensing opening to hold the package of tissue and/or nonwoven products in close alignment with the dispensing opening.

The dispenser may comprise a stack and/or roll of tissue and/or nonwoven products product, preferably a stack and/or roll of wet wipes, which are contained in the volume of the dispenser, wherein the tissue and/or nonwoven products may be contained in a flexible pack which comprises a dispensing opening having a maximum extension in a direction inclined about the same angle as the dispensing opening in the containing body.

The tissue and/or nonwoven products provided on a stack and/or roll may be provided such that the leading edge of the respective sheets to be dispensed extends substantially perpendicular to the maximum extension of the dispensing opening of the flexible pack and/or to a maximum extension of the dispensing opening in the connecting section. As has been discussed above, this specific orientation of the leading edges improves the handling of the sheets to be dispensed.

In order to further improve the dispensing properties, the containing body and the covering body may be formed from a rigid material, in particular from a rigid plastic material such as polypropylene or polyoxymethylene.

The objective of the present disclosure is also solved by a method for dispensing tissue and/or nonwoven products on the basis of the above-described dispenser.

The method includes the insertion of the tissue and/or nonwoven products to be dispensed through an insertion opening into the volume defined by the containing body, covering the insertion opening as well as the dispensing opening of the containing body by the covering body and, in order to dispense a tissue and/or nonwoven products product, move the covering body with respect to the containing body from the closed configuration to the opened configuration.

### BRIEF DESCRIPTION OF THE FIGURES

The embodiments will be discussed in more detail below, with reference to the Figures, in which:

FIG. 1 is a schematic perspective view of a dispenser in a dispensing configuration;

FIG. 2 is a schematic perspective view of the dispenser of FIG. 1 in closed configuration;

FIG. 3 is a schematic perspective view of the dispenser of the preceding Figures in a disassembled state, showing the containing body and the covering body;

FIG. 4 shows the containing body comprising a main section and a connecting section in a perspective view;

FIG. 5 shows the containing body having the main section and the connecting section in another perspective view;

FIG. 6 shows the containing body and a flow pack containing wet wipes, wherein the flow pack is in the process of being inserted into the volume defined by the containing body;

FIG. 7 is a schematic perspective view of a suitable flow pack; and

FIG. 8 is a schematic perspective view of a dispenser having a containing body and a covering body in combination with a cartridge containing wipes.

### DETAILED DESCRIPTION OF THE EMBODIMENTS

In the following, different embodiments of the present disclosure will be described by reference to the attached Figures. Identical or similar features will be denoted by the same reference numerals and repeated description thereof may be omitted in order to reduce redundancies.

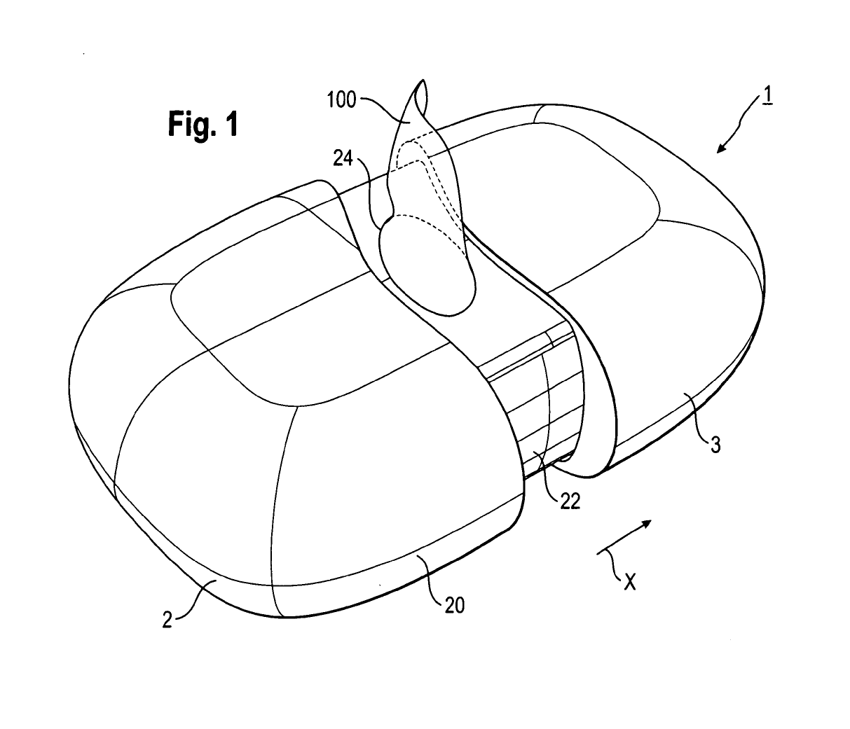

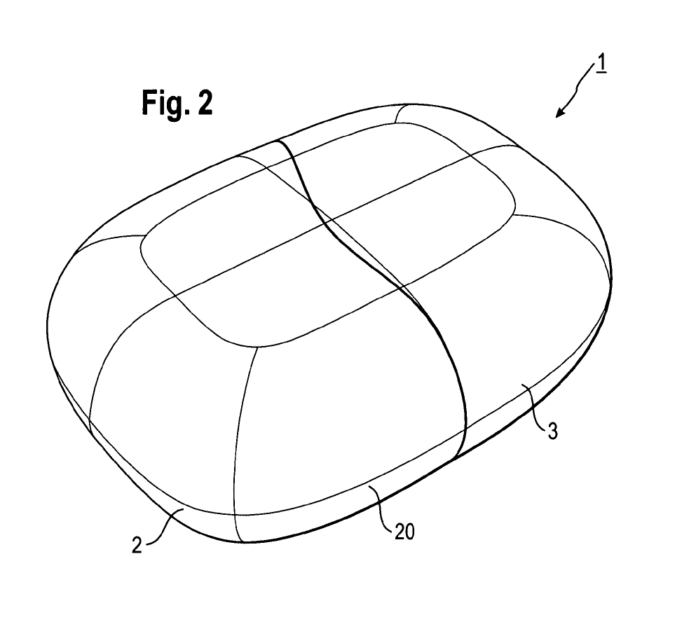

FIG. 1 shows a dispenser 1 in a dispensing configuration in which it is prepared to dispense tissue and/or nonwoven products 100. FIG. 2 shows the same dispenser 1 in a closed configuration.

The dispenser 1 comprises a containing body 2 which defines a volume to receive the tissue and/or nonwoven products 100 to be dispensed, and a covering body 3.

The containing body 2 and the covering body 3 can be moved relative to one another in the direction indicated by “X” in FIG. 1, in order to bring the dispenser 1 from the dispensing configuration shown in FIG. 1 to the closed configuration shown in FIG. 2, and back to the dispensing configuration shown in FIG. 1 again, if needed.

In particular, the containing body 2 and the covering body 3 can be moved in a linear direction with respect to one another in order to transfer the dispenser 1 from the dispensing configuration to the closed configuration and vice versa.

The containing body 2 comprises a main section 20 which is always accessible and visible, in the closed configuration as well as in the dispensing configuration. The containing body 2 also comprises a connecting section 22 which is used to connect the containing body 2 to the covering body 3. The connecting section 22 of the containing body 22 is only accessible and visible when the covering body 3 is moved from the closed configuration to the dispensing configuration, i.e. the covering body 3 and the containing body 2 are moved along the direction X substantially apart from one another.

In the dispensing configuration shown in FIG. 1, a dispensing opening 24 is accessible, wherein the dispensing opening 24 is situated in the connecting section 22 of the containing body 2 in the upper wall, i.e. in a plane defined by the upper wall. From the dispensing opening 24, the tissue and/or nonwoven products 100 received in the volume defined by the containing body 2 can be dispensed.

The dispensing opening 24 shown in FIG. 1 may be closed, however, by the covering body 3 in the closed configuration, as is shown in FIG. 2.

Accordingly, by means of the relative movement of the containing body 2 and the covering body 3 with respect to one another, the dispensing opening 2 can be either opened or closed, depending on whether the dispenser 1 is in the dispensing configuration (FIG. 1) or in the closed configuration (FIG. 2).

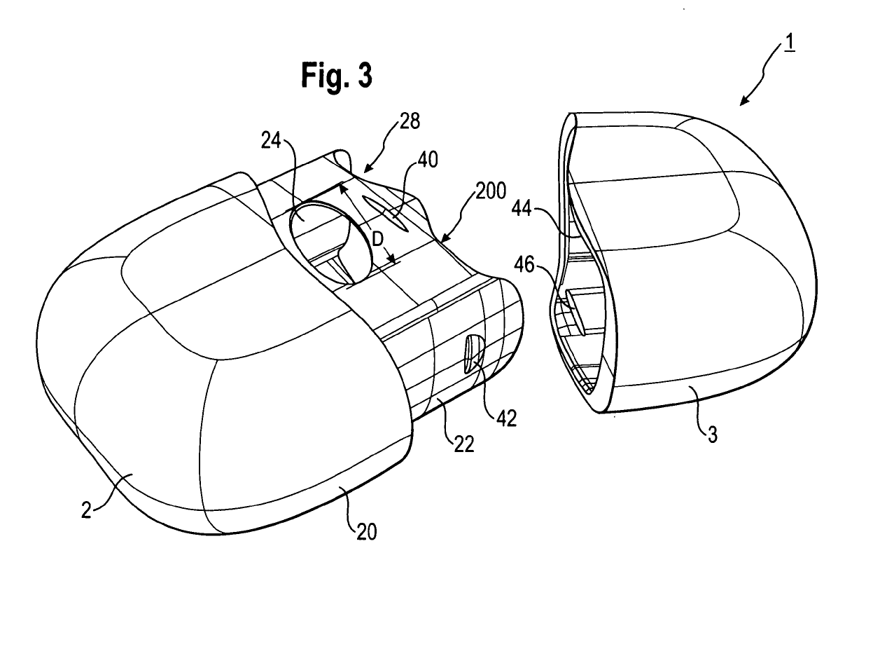

FIG. 3 shows the dispenser of FIGS. 1 and 2 in a disassembled state, in which the containing body 2 and the covering body 3 are taken apart, substantially by pulling the containing body 2 and the covering body 3 along the direction X until the two parts are disassembled.

When disassembling the dispenser 1 into the containing body 2 and the covering body 3, an inserting opening 28 becomes accessible. The inserting opening 28 serves to access the volume 200 defined by the containing body 2 in order to be in a position to refill new tissue and/or nonwoven products into the volume 200.

The insertion opening 28 is defined in a plane of the container body 2 which is situated substantially perpendicular to the plane in which the dispensing opening 24 is situated. The plane in which the insertion opening 28 is defined is also situated perpendicular to the linear moving direction X of the containing body 2 and the covering body 3.

In order to maintain the integrity of the dispenser 1 under dispensing conditions, stopping means 40, 42 are provided in the connecting section 22 of the containing body 2. The stopping means 40, 42 in the connecting section 22 of the containing body 2 engage with complementary sections 44, 46 in the covering body 3.

It might be appreciated that the outer contours of the dispenser 1 in the closed configuration are substantially rounded. Furthermore, it might be appreciated that the contours of the main section 20 of the containing body 2 and the covering body 3 are substantially matching, or complementary to one another, such as to provide the smooth appearance of the dispenser 1 as shown in FIG. 2 in the closed configuration.

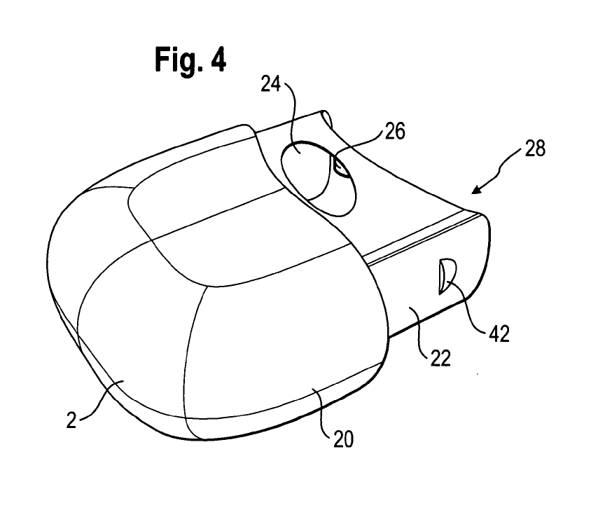

FIG. 4 shows the containing body 2 in yet another perspective view. In this view, a holding means 26 at the dispensing opening 24 can be seen in the form of a clamp into which a section of a pack can be inserted. The holding means 26 is intended to hold a pack of tissue and/or nonwoven products to be inserted into the volume 200 defined by the containing body 2, such that the dispensing opening of the pack remains in close correlation with dispensing opening 24 of the containing body 2. Preferably, the holding means 26 holds a dispensing opening of a pack to be inserted into the dispenser such that the dispensing opening of the pack and the dispensing opening of the dispenser maintain their respective relative position.

The holding means 26 can be provided in the form of a clamp, a bracket, a clip, a push button, an adhesive pad, a hook and loop fastener, a hatch or any other suitable means for holding a pack, and in particular the dispensing opening of the pack, in a fixed position with respect to the containing body.

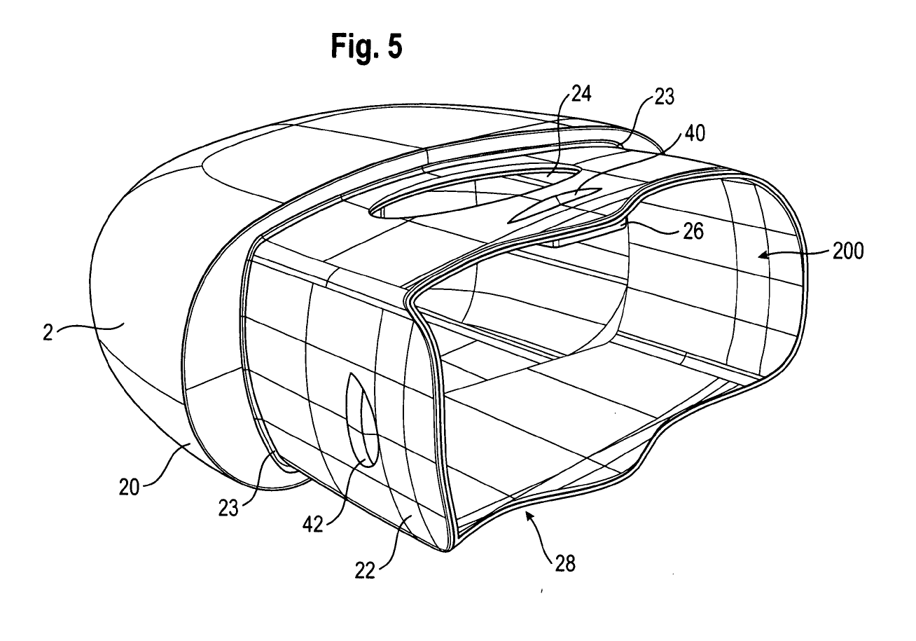

FIG. 5 shows the containing body 2 in yet another perspective view. The main section 20 is shown to have a substantially larger cross-section in a plane along the longitudinal direction A of the containing body 2 than the connecting section 22. Accordingly, the connecting section 22 can be easily inserted into the covering body 3.

In order to further improve the moisture tightness of the dispenser 1, a sealing means 23 in the form of a silicon seal is provided at the transition between the connecting section 22 and the main section 20 of the containing body 2. The sealing means 26 serves to moisture-tightly seal the dispenser 1 in the closed configuration. In particular, when the covering body 3 is moved over the dispensing opening 24 towards the main section 20 of the containing body 2, the rim of the covering body 3 closely abuts on the sealing member 26. Naturally, other sealing solutions than by means of a silicone seal are contemplated such as using a rubber seal, an elastomer seal or any other suitable sealing solutions available in the art.

It will be appreciated that a sealing means can also be provided around the dispensing opening 24 and/or on the front face of the closing body 3.

In order to further improve the sealing properties, the stopping members 40 to 46 can be shaped such as to slightly bias the containing body 2 and the covering body 3 towards the fully closed position, such as to exert a slight biasing force against the sealing 26. Accordingly, the dispenser is, in its closed configuration, closely shut and a slide threshold force has to be overcome in order to move the dispenser into the dispensing position.

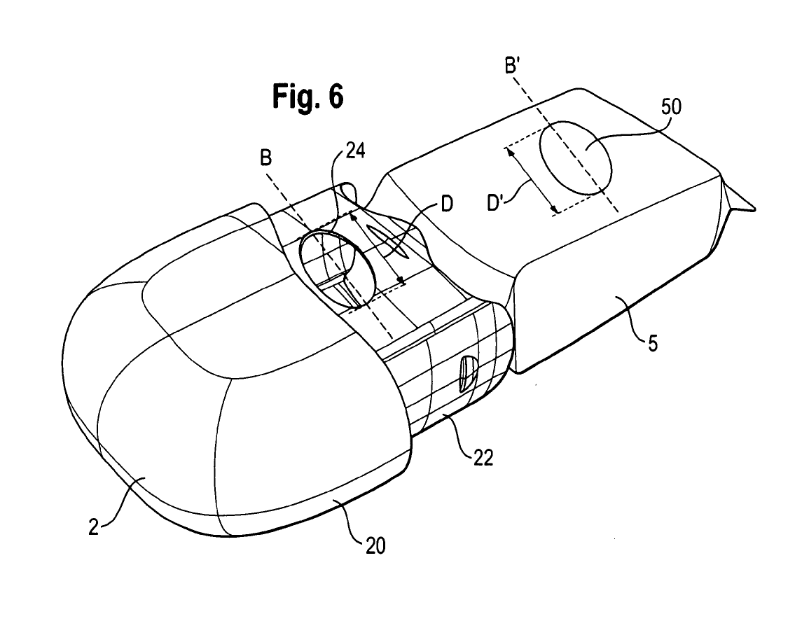

FIG. 6 shows the containing body 2 and a flexible flow pack 5 which can be inserted into the volume 200 defined by the containing body 2. The flow pack 5 is made from a flexible plastic material, in particular a plastic film, in a manner that is conventionally known and contains a stack of wet wipes.

It will be appreciated that the dispensing opening 24 of the containing body 2 has a rather oval form with a maximal extension D which extends along the direction B. This direction B of the dispensing opening 24 is slightly inclined with respect to the longitudinal axis A of the containing body 2. The inclination angle is typically chosen between 5° and 45°, preferably between 5° and 35°, more preferably between 10° and 25°, most preferably between 12° and 17°, for example 15°. In the present case, the longitudinal extension of the dispensing opening 24 is inclined by approximately 15° with respect to the longitudinal axis A of the containing body 2.

The flow pack 5 has a dispensing opening 50 which has a maximum extension D′, wherein the maximum extension D′ directed in a direction B′ which is inclined such as to correlate to the inclination of the dispensing opening 24 of the containing body 2. In the fully-inserted position, the flow pack 5 is substantially fully inserted into the volume 200 defined by the containing body 2.

By means of the tilting of the dispensing opening 24 of the containing body 2, an easy alignment of the leading ends of the tissue and/or nonwoven products, preferably the wet wipes, is possible. In particular, by means of the inclined dispensing opening 24, it is not necessary anymore to situate the stack of tissue and/or nonwoven products exactly within a defined small range such as to be in a position to grasp the leading end of the paper, but this range can be extended substantially.

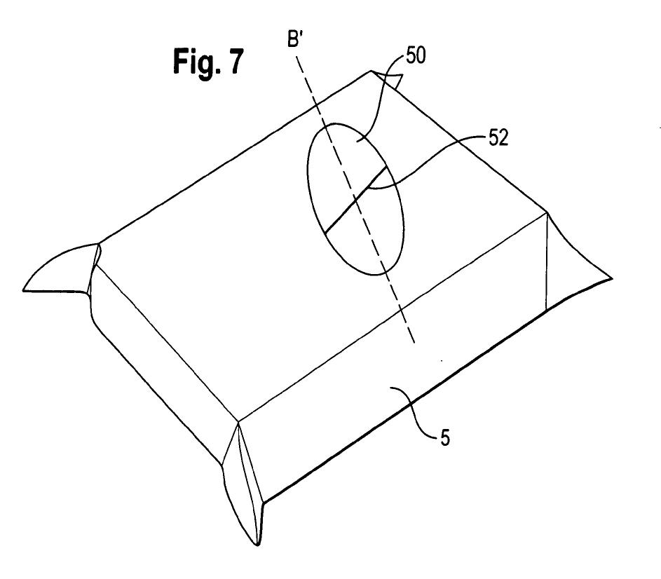

FIG. 7 shows the flow pack shown in FIG. 6 in another perspective view. In particular, the dispensing opening 50 is inclined with respect to the longitudinal direction of the flow pack.

In this flow pack, the dispensing opening 50 is shown in an opened state such that the leading edge 52 of the top sheet to be dispensed is visible. The leading edge extends along a direction substantially perpendicular to the direction B′ of the maximum extension of the dispensing opening. It becomes immediately apparent that it is very easy for a user to grasp the leading edge 52 as there is much room around it in a direction perpendicular to the leading edge 52 which enables the user to easily grip it.

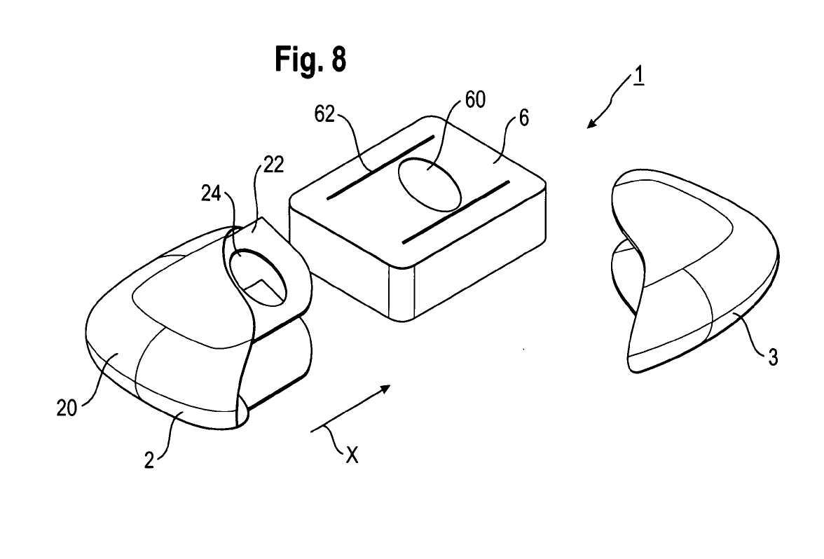

FIG. 8 shows another embodiment of a dispenser 1 in which the containing body 2 likewise includes a connecting section 22 and a main section 20, and the covering body 3 is present to cover the dispensing opening 24 and can be moved in a direction X with respect to the containing body 2, in order to bring the dispenser 1 from a dispensing configuration to a closed configuration.

A cartridge 6 can be inserted into the dispenser housing, wherein the cartridge is guided by rails 62 into the containing body 2. Dispensing opening 60 is inclined by the same angle as dispensing opening 24 in the containing body.

As to the tissue and/or nonwoven products that can be used in connection with the dispenser, typical wet wipes can be used as well as other personal care products. In particular, the present dispenser is also intended to be used with after-sex wipes, which are used for freshening up after sex.

1. Dispenser for dispensing tissue and/or nonwoven products, the dispenser comprising:
a dispenser housing;
a flexible pack; and
products to be dispensed,
the dispenser housing comprising a containing body defining a volume for receiving the products to be dispensed and a covering body,
wherein the containing body comprises a main section and a connecting section, the connecting section having dimensions to be at least partly received in the covering body, and
wherein the containing body and the covering body are connected to one another by the connecting section such that the covering body is movable with respect to the containing body from a closed configuration to a dispensing configuration,
the dispenser housing further comprising a dispensing opening in the connecting section for dispensing, in the dispensing configuration, the products to be dispensed from the volume, wherein covering body covers the dispensing opening in the closed configuration,
wherein the dispensing opening has a maximum extension which is aligned in a direction inclined with respect to the general extension of the containing body,
wherein containing body comprises a holding element in the vicinity of the dispensing opening, the holding body adapted to hold an opening of a package of products in close alignment with the dispensing opening,
wherein the products to be dispensed comprise a stack and/or roll of tissue and/or nonwoven products, and
wherein the flexible pack contains the products to be dispensed, and the flexible pack is contained in the volume of the dispenser housing, the flexible pack comprises a flexible pack dispensing opening having a maximum extension in a direction inclined at about the same angle, with respect to the general extension of the containing body, as the dispensing opening in the containing body.

2. Dispenser according to claim 1, wherein the dispensing opening is defined in a first plane of the connecting section, and an insertion opening for inserting the tissue and/or nonwoven products into the volume is defined in a second plane, the second plane being perpendicular to the first plane.

3. (canceled)

4. Dispenser according to claim 1, wherein the containing body and the covering body are slidable from the closed configuration to the dispensing configuration along a linear movement direction.

5. Dispenser according to claim 4, wherein the dispensing opening is situated in a plane which extends parallel to the direction of the linear movement direction, and an insertion opening is defined in a plane perpendicular to the direction of the linear movement direction.

6. Dispenser according to claim 1, wherein the relative movement of the containing body and the covering body is restricted by at least one stopping element such that the movement of the containing body and the covering body is restricted between the closed configuration and the dispensing configuration.

7. Dispenser according to claim 6, wherein the at least one stopping element is provided in the form of a stopping protrusion and/or stopping depression in the connecting section, and a complementary stopping protrusion and/or stopping depression in the covering body.

8. Dispenser according to claim 6, wherein the at least one stopping element is configured to be overcome by means of using a higher force, in order to disassemble the containing body and the covering body.

9. Dispenser according to claim 1, wherein the connecting section has reduced outer dimensions with respect to the main section of the containing body in a plane perpendicular to a direction of the relative movement of the containing body and the covering body.

10. Dispenser according to claim 9, wherein an insertion opening for inserting the tissue and/or nonwoven products into the volume defined in the containing body is situated in the connecting section in a plane perpendicular to the direction of the relative movement.

11. Dispenser according to claim 1, wherein the containing body and the covering body form together, in the closed configuration, a substantially smooth and even outer surface of the dispenser housing.

12. Dispenser according to claim 1, wherein the main section of the containing body and the covering body have complementary outer shapes.

13. Dispenser according to claim 1, wherein a sealing is present at the containing body and/or the cover body such as to provide a moisture-proof sealing when the dispenser housing is in the closed configuration.

14. (canceled)

15. Dispenser according to claim 1, wherein the holding element is provided in the form of a clamp, a bracket, a clip, a push button, an adhesive pad, a hook and loop fastener, or a hatch.

16. (canceled)

17. (canceled)

18. Dispenser according to claim 1, wherein the tissue and/or nonwoven products provided on a stack and/or roll are provided such that the leading edge of the respective sheets to be dispensed extends substantially perpendicular to the maximum extension of the dispensing opening of the flexible pack and/or to a maximum extension of the dispensing opening in the connecting section.

19. Dispenser according to claim 1, wherein the containing body and the covering body are formed from a rigid material.

20. Flow pack for a dispenser housing,
the dispenser housing comprising a containing body defining a volume for receiving the products to be dispensed and a covering body, wherein the containing body comprises a main section and a connecting section, the connecting section having dimensions to be at least partly received in the covering body, and wherein the containing body and the covering body are connected to one another by the connecting section such that the covering body is movable with respect to the containing body from a closed configuration to a dispensing configuration, the dispenser housing further comprising a dispensing opening in the connecting section for dispensing, in the dispensing configuration, the products to be dispensed from the volume, wherein covering body covers the dispensing opening in the closed configuration, wherein containing body comprises a holding element in the vicinity of the dispensing opening, the holding body adapted to hold an opening of a package of products in close alignment with the dispensing opening,
wherein the flow pack has dimensions to fit into the volume of the dispenser housing, and the flow pack has a flow pack dispensing opening with a maximum extension which is directed in a direction which is inclined with respect to the main extension of the flow pack.

21. Flow pack according to claim 20, wherein the flow pack contains a stack and/or roll of tissue and/or nonwoven products, wherein a leading edge of a sheet to be dispensed is aligned substantially perpendicular to the maximum extension of the dispensing opening.

22. Method for dispensing tissue and/or nonwoven products from a dispenser according to claim 1, the method including the steps:
inserting the tissue and/or nonwoven products to be dispensed through the insertion opening into the volume defined by the containing body,
covering the insertion opening as well as the dispensing opening of the containing body by the covering body, and,
in order to dispense a tissue and/or nonwoven products product, moving the covering body with respect to the containing body from the closed configuration to the opened configuration.

23. Dispenser according to claim 1, wherein the products to be dispensed are wet wipes.

24. Dispenser according to claim 3, wherein the maximum extension of the dispensing opening is inclined with respect to the general extension of the containing body at an angle of 5 to 45°.

25. Dispenser according to claim 3, wherein the maximum extension of the dispensing opening is inclined with respect to the general extension of the containing body at an angle of 12 to 17°.

26. Dispenser according to claim 11, wherein the dispenser housing has, in the closed configuration, rounded outer contours.

27. Dispenser according to claim 19, wherein the containing body and the covering body are formed from a rigid plastic material.

28. Flow pack according to claim 20, wherein the maximum extension of the flow pack dispensing opening is inclined with respect to the main extension of the flow pack at an angle of 5 to 45°.

29. Flow pack according to claim 20, wherein the maximum extension of the flow pack dispensing opening is inclined with respect to the main extension of the flow pack at an angle of 12 to 17°.
